(19) United States
(12) Patent Application Publication
(10) Pub. No.: US 2009/0211424 A1
(43) Pub. Date: Aug. 27, 2009

(54) Method and Device for the Mechanical Structuring of Flexible Thin-Film Solar Cells

(76) Inventors: Hans-Ulrich ZUEHLKE, Jena (DE); Torsten Reichl, Schleusingen (DE); Gabriele Eberhardt, Jena (DE); Roland Henning, Jena (DE)

Correspondence Address: DUANE MORRIS LLP - NY;PATENT DEPARTMENT, 1540 BROADWAY, NEW YORK, NY, 10036-4086, US

(21) Appl. No.: 12/389,616

(22) Filed: Feb. 20, 2009

(30) Foreign Application Priority Data
Feb. 22, 2008 (DE) DE102008010783.2

(51) Int. Cl. B26D 3/06; B26D 7/01

(52) U.S. Cl. 83/875; 83/152; 83/154

(57) ABSTRACT

The invention relates to a method and to a device for the mechanical structuring of thin-film solar cells which are carried on a flexible carrier layer in the form of a material web. The material web is held on a support, where the groove areas, into which grooves are introduced for structuring with a mechanical scoring tool, are pulled onto elastic bases, by holding the material web by frictional engagement over adjacent groove-free areas.

### FIELD OF THE INVENTION

The invention relates to the field of solar cells and more particularly to a method and to a device for structuring flexible thin-film solar cells.

### BACKGROUND OF THE INVENTION

Mechanical structuring to form the layer structure of thin-film solar cells with rigid carrier layers, such as glass or aluminum, is known, and has been mastered technologically. Structuring refers to the introduction of grooves of different depths into the layer structure, parallel to the external edges of the thin-film solar cells, for the purpose of electrically connecting different layers, or insulating them from each other. Usually, two grooves that present as small as possible a separation from each other are produced for each thin-film solar cell.

For this purpose, pressure-regulated needle holders with specially shaped needle tips are usually used, as described, for example, in EP 1544172 A1. No special demands are placed there on the work piece support or the work piece holder, because the carrier layer itself constitutes a hard and solid basis for the layers to be structured, and the carrier layer remains uninfluenced by the structuring.

For thin-film solar cells that are manufactured using thin-film technology, the carrier layer serves exclusively as a support for the applied functional layers. Instead of rigid materials, such as glass, it is also advantageous to use flexible layers, such as plastic films or metal films, for this purpose.

Thin-film solar cells with flexible carrier layers not only open broader possibilities for use, but they can also be manufactured with larger surface areas because of the possibility of being processed and stored in the form of reels.

The competitive advantage, which is the result particularly of the flexibility and the low weight of such thin-film solar cells, entails, however, more difficult requirements associated with the structuring.

In the description of the state of the art from DE 10 2004 016 313 A1, it is shown that mechanical scoring is less suitable for thin-film solar cells that are formed by deposition on the flexible material. In contrast to glass, which can be used alternatively as a material for the carrier layer, flexible support materials would yield to the pressure of the scoring needle, and have a less flat surface, so that mechanical scoring is affected with more serious problems. To circumvent these problems, a laser method for separation and structuring is proposed in DE 10 2004 016 313 A1.

Methods that are known from the state of the art for mechanical structuring largely concern the optimization of the tool. No indications are given regarding the work piece support.

Usually, a plurality of thin-film solar cells is produced jointly on a carrier layer, which is then cut after the manufacture of the thin-film solar cells, to separate the thin-film solar cells from each other.

For the manufacture of a plurality of rectangular thin-film solar cells, the layer structure provided for the thin-film solar cells is either to be applied over the entire surface, or, preferably, in the form of preformed thin-film solar cells on the carrier layer in a grid-shaped pattern, where the edges of the preformed thin-film solar cells run parallel and at right angles to one another with respect to each other and with respect to the edge of the material web. Correspondingly, the grooves to be introduced by structuring into the prefigured thin-film solar cells can all be introduced in the same direction, where a joint structuring, already in the composite prior to the separation, by separation of the support material is advantageous.

Thin-film solar cells with flexible carrier layers are preferably prefabricated as a material web that can be wound and processed. The material web is then section-by-section between unwinding and winding. The material web can also be present in a length that corresponds to a processable material web section.

In the following explanations, the point of departure is the practical case where the material web has a web length that is a multiple of the web width and is to be processed in sections.

The relative movement between the tool and the material web as a work piece that is required for the introduction of grooves can run, for this purpose, either in the direction of the web length (web direction) or at a right angle, to produce parallel grooves between two of the later outer edges of the thin-film solar cells.

Using individual scoring needles or needle combs with a plurality of scoring needles, which can optionally be adjusted, at a mutual separation, as a tool for the mechanical introduction of the grooves is known technology. As an embodiment of the scoring needles, the state of the art discloses different geometries, different scoring angles at which the scoring needles can be guided over the work piece, as well as different measures to press the scoring needles onto the workpiece, optionally with a regulated force. There is no indication in the state of the art to the effect that special measures have to be taken with respect to the support of the web material.

### SUMMARY

The present invention is based on addressing the problem of developing a method by means of which thin-film solar cells with a flexible carrier layer can be mechanically structured with high quality.

An additional problem addressed by the present invention is the development of a device that is suitable for the foregoing method.

The problem of developing the method for the mechanical structuring of thin-film solar cells is solved according to the method set forth in claim 1, and the problem of developing a device for the mechanical structuring of thin-film solar cells is solved according to the device set forth in claim 3.

Advantageous embodiments are described in the claims that depend respectively from claims 1 and 3.

### BRIEF DESCRIPTION OF THE DRAWINGS

The method and device of the present invention is described in greater detail below in connection with on an example with reference to the annexed drawings, in which:

FIG. 1a shows a support for the material web section to be processed, and

FIG. 1b shows a material web section, as formed for processing with the assistance of the installation according to FIG. 1a.

### DESCRIPTION OF AN EMBODIMENT

With the method according to the invention, prefabricated thin-film solar cells 2 with a preformed layer structure are to be structured on a flexible carrier layer 1. The carrier layer 1 is in the form of a material web, which is wound up over its length on a reel, and on which the prefabricated thin-film solar cells 2 are arranged with their subsequently formed edges, which are produced by the separation of the thin-film solar cells 2 after the structuring, in parallel to the web edges.

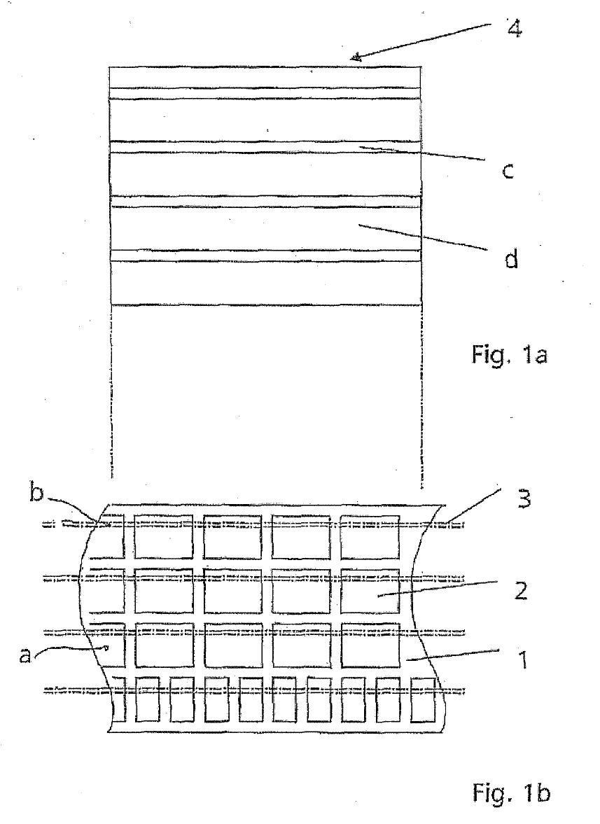

An example of such a material web is shown in FIG. 1b.

On a flexible carrier layer 1, four rows of thin-film solar cells 2, with their finished layer structure, are applied. As an example, three rows may have thin-film solar cells 2 each having the same dimensions, for example, 20 mm×20 mm, while a fourth row (illustrated on FIG. 1(b) adjacent the edge of the web that is shown closer to the bottom of the sheet of the drawings) is formed from thin-film solar cells 2 of smaller dimensions, for example, 10 mm×10 mm.

Because the grooves 3 for the structuring should run parallel to two facing edges of the thin-film solar cells 2, the grooves 3 can be introduced over the entire length of the material web either all parallel to one lateral edge of the carrier layer 1, or at a right angle with respect to the latter.

In this example, the grooves 3 run parallel to the side edges (the ones shown as parallel to the top and bottom edges of the sheet of the drawings) of the carrier layer 1, and they are represented as dotted lines. The separation between two grooves 3, which in each case run over a thin-film solar cell 2, and which are referred to below as a groove pair, is only approximately 100-150 μm.

The mutual separation at which the groove pairs have to be introduced are obtained from the predetermined sizes for the individual thin layer solar cells 2 and their arrangement on the support layer 1. In the present example, for instance, an 80 mm width of the support layer 1, and, thus, the width of the material web, and a groove pair separation of 22 mm are obtained.

To process the material web, it is unwound from a first reel, led over a support 4, on which the material web is fixed consecutively in sections during the processing, and then wound onto a second reel. The length and the width of the fixed material web section are determined by the dimensions of the support 4.

For the introduction of grooves 3, a scoring tool is guided above the fixed material web section relative to the material web, either parallel to the material web edge or at a right angle to the latter.

The scoring tool can be an individual scoring needle or a scoring comb, consisting of several scoring needles arranged on a straight line and preferably adjustable in terms of their mutual separation.

The required relative movement between the scoring tool and the material web can, as already mentioned, be, in principle, a linear movement that is either parallel or at a right angle with respect to the material web edge, and thus the winding direction of the material web, in order to produce grooves 3 with the scoring tool in the layer structure for structuring the prefabricated thin-film solar cell modules.

For a relative movement at a right angle to the material web edge, the material web section that is fixed to the support 4 is held in a fixed position, and the scoring tool is guided over the width of the material web section.

For a relative movement parallel to the material web edge, the scoring tool can be guided analogously over the length of the material web section.

In both cases, either the winding movement has to be interrupted, or additional measures have to be taken, to keep a material web section temporarily in a fixed position, in spite of the constant winding speed. Usually, additional buffer reels are used for this purpose, which, change the material web path between the first and the second reel as a result of being lifted and lowered.

For a relative movement parallel to the material web edge, as provided in the described embodiment example, the scoring tool can also be used, or the material web can be used. For this purpose, the winding movement can be used advantageously. According to the invention, the support 4 itself undergoes a movement in the winding direction, which will be explained in greater detail below.

According to the invention, it is essential for the method that the material web section to be processed is introduced over groove-free areas ‘a’, which are strips into which no grooves 3 are introduced, held with friction lock on the support 4, and pulled onto an elastic base, over adjacent groove areas ‘b’, which are strips that are covered substantially by the groove pairs.

The subdivision of the material web section into groove-free areas ‘a’ and groove areas ‘b’ is determined by the arrangement and the dimensioning of the prefabricated thin-film solar cells 2, and thus the length of the grooves 3, i.e., the separations of the groove areas ‘b’ from one another correspond to the separations of the groove pairs to be introduced.

In order to hold sections of the material web, as described, on support 4, the support 4, as a result of its dual function, is subdivided into score areas ‘c’ and holding areas ‘d’, where the score areas ‘c’ are not smaller than the width of a groove pair, and the score areas ‘c’ are mutually arranged in a way that is identical to the mutual arrangement of the groove pairs. The holding areas ‘d’ correspond, in size and mutual arrangement, to the size and the arrangement of the groove-free areas ‘a’ on the material web. Such a support 4 is represented in FIG. 1a.

The score areas ‘c’ are formed by strips made of an elastic base, for example, a thermoplastic elastomer. As a result, on the one hand, a higher coefficient of static friction, in comparison to the usual metallic support, between the carrier layer 1 and the support 4, is created in the score areas ‘c’, and, on the other hand, the energy that is introduced during the scoring of the grooves 3 by the processing forces into the carrier layer 1 is taken up in part by the elastic base. As a result, the carrier layer 1 is prevented from being pushed together in the processing direction, and a resulting, so-called stick-slip effect, which always occurs between two bodies that are applied against each other if the static friction is overcome by the energy introduced, is likewise prevented. The scoring tool can be led with a greater pressing force over the layer structure of the prefabricated thin-film solar cells 2. The grooves 3 of predetermined depth can thus be produced with better quality, and in only one or a few passes, than with the usual standard supports made of metal.

The holding areas ‘d’ should fix the carrier layer 1 by frictional engagement in the overlying material web section on the support 4.

Independently of the material of the carrier layer 1, the same result can be achieved by suction using a low pressure. For this purpose, the holding areas ‘d’ are designed as surfaces for suction, which are connected to a vacuum chamber by a plurality of suction openings, or a porous material, for example, foamed aluminum or foamed high-grade steel.

In the case of a metal carrier layer 1, it is possible to use a holding method that uses magnetic force. The holding areas ‘d’ are formed accordingly by magnetic strips. In this case, the support 4 can be designed advantageously as a revolving conveyor belt, so that, although the material web section is fixed to the support 4, it is also moved simultaneously in the winding direction by means of a drive that is connected to the conveyor belt, at a rate that is adjusted to the winding rate. Ideally, the second reel for winding up the material web, and the conveyor belt are driven synchronously with a drive. Such a solution is particularly advantageous if the grooves 3 are produced in a single passage of a scoring tool. The scoring tool can then be held in a fixed position. The scoring tool is formed advantageously from two scoring combs, each having a group of needles with identical needle number and needle separation, and are mutually offset by the separation of the needles forming a group of grooves.

### LIST OF REFERENCE CHARACTERS

| | |
|---|---|
| 1 | Carrier layer |
| 2 | Thin-film solar cells |
| 3 | Grooves |
| 4 | Support |
| a | Groove-free area |
| b | Groove area |
| c | Score area |
| d | Holding area |

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A method for the mechanical structuring of thin-film solar cells carried on a material web flexible carrier layer thereby forming a layer structure, comprising, holding a section of said material web on a support, moving a scoring tool linearly relative to said support to score grooves in predetermined groove areas of said section of material web into said layer structure over holding areas that lie between said groove areas, by frictional engagement on said support, and said groove areas are pulled on elastic bases.

2. The method according to claim 1, wherein said material web, after unwinding from a first reel and before the winding onto a second reel, is guided over said support, and is held there in sections.

3. A device for the mechanical structuring of thin-film solar cells carried on a material web flexible carrier layer thereby forming a layer structure, by scoring grooves having a predetermined mutual separation that are arranged parallel to or at a right angle to a side edge of said material web, comprising
a support on which said material web lies at least in sections during said scoring, said support having score areas arranged so as to coincide with the arrangement of said grooves, said score areas formed by elastic material, and holding areas located between said score areas over which said material web section is held on said support,
a scoring tool, and
means for effecting relative movement of said scoring tool with respect to said material web along said grooves.

4. A device according to claim 3, wherein said holding areas are formed by suction surfaces connected to a vacuum device.

5. The device according to claim 3, wherein said holding areas are formed by magnetic strips.

6. The device according to claim 4, wherein said support is a revolving conveyor belt, and wherein said means for effecting said relative movement is a drive for said conveyor belt.

7. The device according to claim 3, wherein said elastic material of the score area is a thermoplastic elastomer.
